(19) United States
(12) Patent Application Publication
(10) Pub. No.: US 2004/0247217 A1
(43) Pub. Date: Dec. 9, 2004

(54) Gear drive housing having a continuously variable bearing adjustment system with an integral seal carrier

(76) Inventors: Michael E. Konruff, Burlington, WI (US); Kenneth W. Wheelock, New Berlin, WI (US)

Correspondence Address: Intellectual Property Department/SGM, Hamilton Sundstrand Corporation, 4747 Harrison Ave., P.O. Box 7002, Rockford, IL, 61125-7002, US

(21) Appl. No.: 10/830,184

(22) Filed: Apr. 23, 2004

Related U.S. Application Data
(63) Continuation-in-part of application No. 10/016,378, filed on Dec. 10, 2001, now abandoned.
(60) Provisional application No. 60/255,011, filed on Dec. 12, 2000.

(51) Int. Cl. F16C 25/00; F16C 23/00

(52) U.S. Cl. 384/583

(57) ABSTRACT

A gear drive that has a continuously variable float and preload bearing adjustment system with an integral seal carrier for the bearings on drive shafts that have a fixed axial alignment within the gear drive, the adjustment system comprising a housing bore in a housing for the gear drive with threads that mate with threads in a combination bearing adjustment and drive shaft seal carrier to provide continuous adjustment of drive shaft bearings without disassembly.

### CROSS REFERENCE TO RELATED APPLICATIONS

This application is a Continuation-in-Part application of application Ser. No. 10/016,378, filed 10 Dec. 2001, claiming the benefit of the filing date of Provisional Application Ser. No. 60/255,011, filed 12 Dec. 2000.

### BACKGROUND OF THE INVENTION

Industrial gear drives frequently employ single row tapered roller bearings in their design. One of the important advantages of this type of bearing is that they can be adjusted with either a clearance, commonly referred to as float, or preload setting to suit their intended loading conditions and compensate for manufacturing tolerances. Bearing adjustments are normally done with either metal or composite material shims that are sandwiched between the bearing and a bearing cover that is bolted to the gear drive housing. A shaft seal is required for a drive shaft that protrudes from the gear drive. The shaft seal is usually located in the bearing cover. To keep the seal concentric with the shaft it is to seal, the bearing cover has a machined register that has a close fit with it's respective bore in the gear drive housing.

Shim-type bearing adjustments require assemblers to tighten the bearing cover to the housing, take a bearing adjustment reading, calculate the thickness of shim required, and either grind a shim or select pre-dimensioned shims to make up the required shim thickness. After the shims with desired thickness are selected, the assembler must recheck the bearing setting to ensure that the shims have not over compressed or were toleranced at their upper or lower limits that would cause a total thickness of incorrect value. This process can be time consuming for the assembler.

A problem with composite shim materials is that they will compress and creep over a short time and change the bearing setting from the intended adjustment. Because of the flexible nature and compression characteristics of the material, the bolted joint may be subject to forces that will cause the joint to open and create a leak path for oil. Although metal shims will not compress, the adjustment procedure is the same as the composite shims.

Continuous adjustment systems for shaft bearings in gear drives have been offered in the form of adjustment nuts on the shafts. Some other systems have been offered with a bearing adjustment system that is continuously adjustable within a housing bore. However, these types of continuously adjustable systems lack any sort of seal carrier for drive shafts that protrude from the housing, thereby limiting their application.

Continually adjustable bearing systems for axial alignment of a cam follower and a cam on the output shaft of intermittently moving index device have been available with integral seal carriers, but these systems require such bearing are not designed for simple float and preload adjustments of the typical continuous motion gear drive that has a drive shaft that is in fixed axial alignment with the gear drive housing.

### SUMMARY OF THE INVENTION

The invention relates to a gear drive that has a continuously variable float and preload bearing adjustment system with an integral seal carrier for the bearings on drive shafts that have a fixed axial alignment within the gear drive. Threads in a housing bore in a housing for the gear drive mate with threads in a combination bearing adjustment and seal carrier to provide continuous adjustment of drive shaft bearings without disassembly.

The invention generally comprises a gear drive having at least one continuously variable drive shaft bearing float and preload adjustment system with an integral seal carrier for a bearing assembly on a drive shaft that protrudes from the gear drive comprising a threaded housing bore in a housing for the gear drive, a threaded adjustment ring with ring threads that mate the threads in the housing bore and a thrust surface that constrains a bearing assembly for a drive shaft that protrudes from the housing in fixed axial alignment through the adjustment ring to provide adjustable float and preload of the bearing assembly and at least one shaft seal mating with the drive shaft mounted within the adjustment ring.

### DESCRIPTION OF THE DRAWINGS

FIG. 1 shows a cut-away side view of a typical shim-type bearing adjustment system with an integral seal carrier according to the prior art.

FIG. 2 shows a cut-away side view of a typical continuously variable bearing adjustment system with an integral seal carrier according to the invention.

FIG. 3 shows a top view of the continuously variable bearing adjustment system with an integral seal carrier shown in FIG. 2.

FIG. 4 is a cut-away side view of an adjustment ring used in the continuously variable bearing adjustment system with an integral seal carrier shown in FIGS. 2 and 3.

FIG. 5 is a top view of the adjustment ring shown in FIG. 4.

FIG. 6 is a cut-away side view of another adjustment ring used in the continuously variable bearing float and preload adjustment system with an integral seal carrier shown in FIGS. 2 and 3.

FIG. 7 is a cut-away side view of the adjustment ring shown in FIG. 6.

### DESCRIPTION OF THE EMBODIMENT

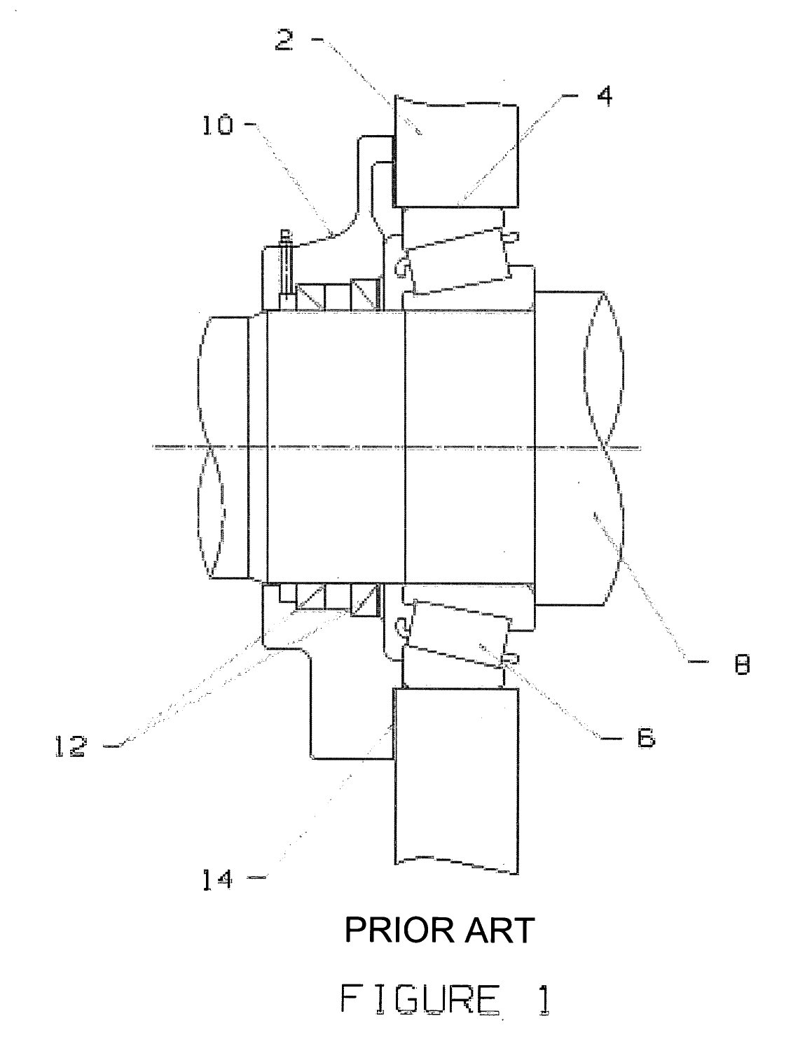

Referring to the drawings, wherein like numbered items identify like or similar parts throughout the views, FIG. 1 shows a cut-away side view of a typical shim-type bearing float and preload adjustment system with an integral drive shaft seal carrier according to the prior art. A gear drive with a housing 2 has at least one housing bore 4 to receive a bearing assembly 6 for a drive shaft 8 that protrudes from the housing 2 in fixed axial alignment with the housing 2. A seal cage 10 that holds at least one annular drive shaft seal 12 for the drive shaft 8 is fastened to the housing 2. One or more shims 14 may be needed between the seal cage 10 and the housing 2 to provide proper float and preload adjustment of the bearing assembly 6.

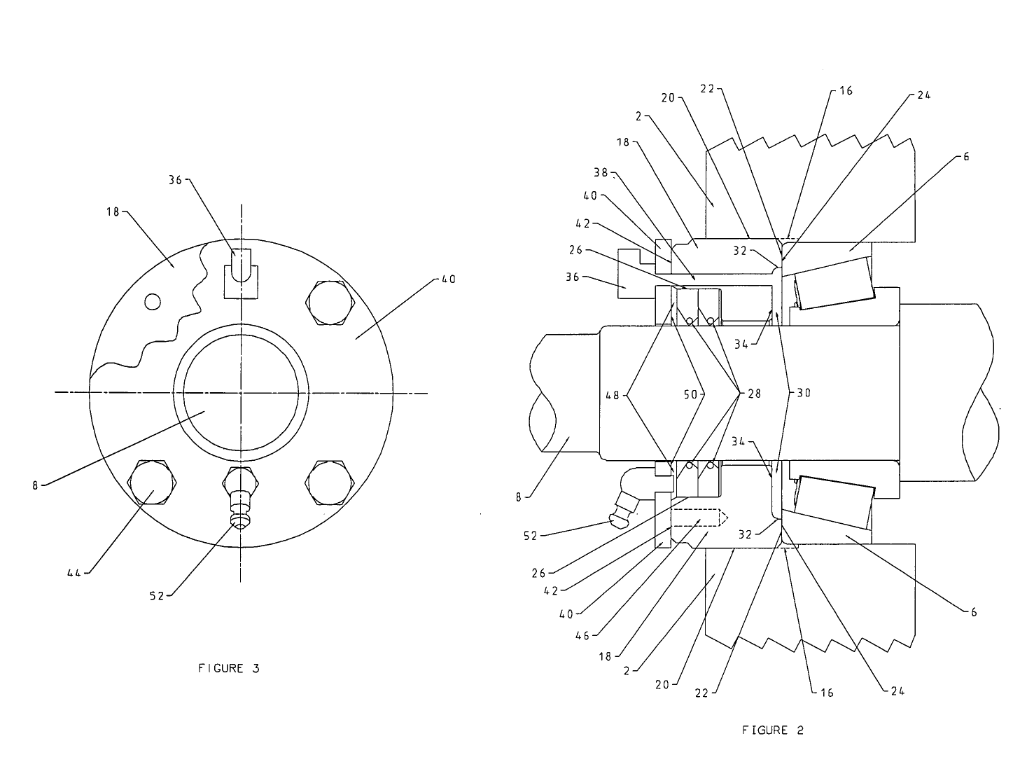

FIG. 2 shows a cut-away side view of a typical continuously variable bearing adjustment system with an integral drive shaft seal carrier according to the invention. FIG. 3 shows a top view of the continuously variable float and preload bearing adjustment system with an integral drive shaft seal carrier shown in FIG. 2. Referring to FIGS. 2 and 3, a gear drive with a housing 2 has at least one housing bore 4 with a threaded bore segment 16. A threaded adjustment ring 18 has a threaded axial outer surface segment 20 that mates with the threaded bore segment 16.

The adjustment ring 18 also has an inner radial thrust surface 22 that adjoins an inner radial surface 24 of a bearing assembly 6 for a drive shaft 8 that protrudes from the housing 2. The adjustment ring 18 has inner axial surface segment 26 that carries at least one drive shaft seal 28 for the drive shaft 8.

For vertical shaft and pressure lubricated drive applications, a cavity 30 formed by an axial surface segment 32 and a radial surface segment 34 adjoining the bearing assembly 6 serves as a lubricant reservoir for the bearing assembly 6. It may be pressure lubricated through a standard pressure lubrication fitting 36 that is in communication with the cavity 30 through a channel 38. An annular ring cover 40 is fastened to an outer annular surface 42 of the adjustment ring 18, typically with threaded bolts 44 that engage threaded holes 46 in the face of the outer surface 42. A cavity 48 formed between a portion of the inner axial surface segment 26 of the adjustment ring and an inner radial surface 50 of the cover 40 may serve as a grease purge cavity that may be purged through a standard grease fitting 52 mounted on the cover 40 and communicating with the cavity 48.

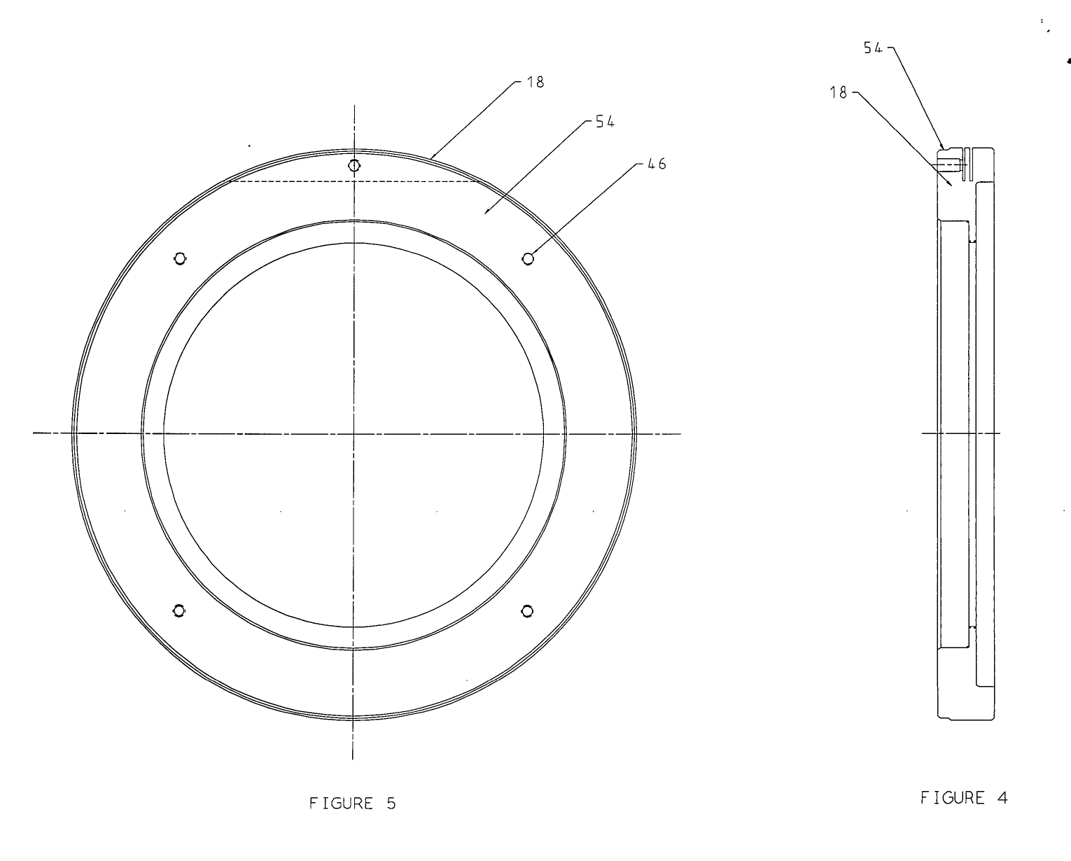

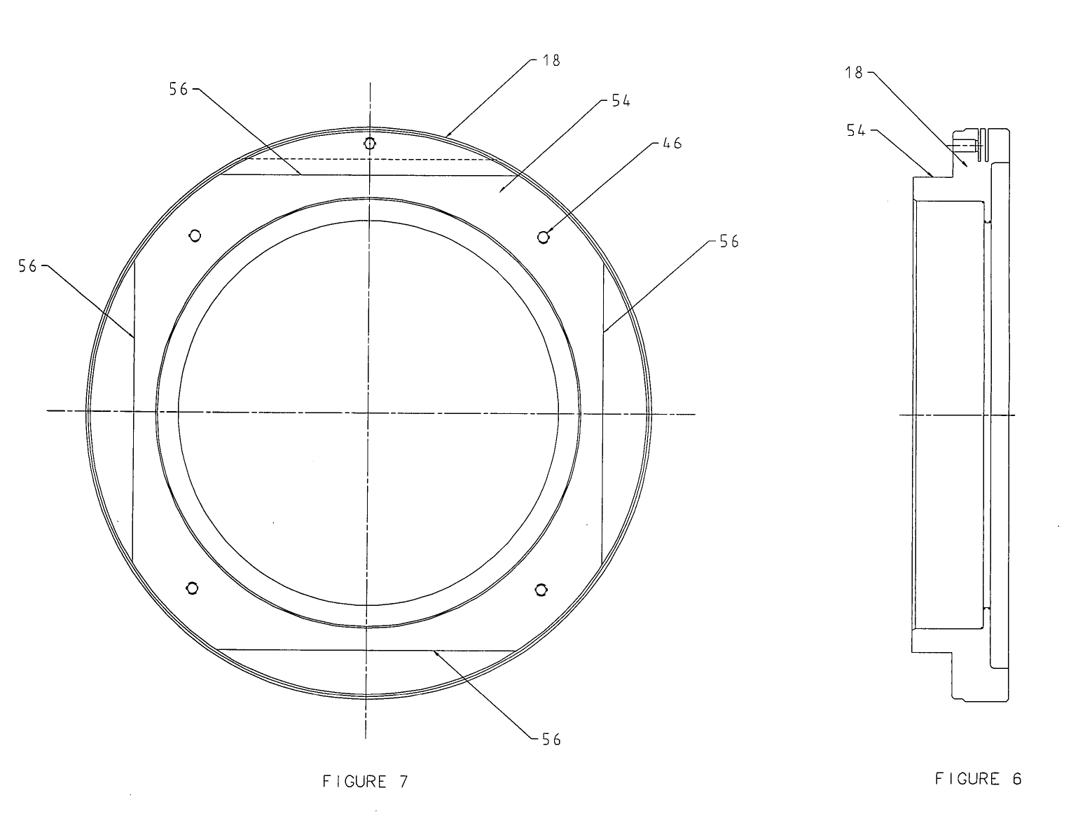

FIG. 4 is a cut-away side view of an adjustment ring used in the continuously variable float and preload bearing adjustment system with an integral drive shaft seal carrier shown in FIGS. 2 and 3. FIG. 5 is a top view of the adjustment ring shown in FIG. 4. FIG. 6 is a cut-away side view of another adjustment ring used in the continuously variable bearing float and preload adjustment system with an integral drive shaft seal carrier shown in FIGS. 2 and 3. FIG. 7 is a cut-away side view the adjustment ring shown in FIG. 6. As shown in FIGS. 4 through 7, an exposed outer nose surface 54 of the adjustment ring 18 may be formed to facilitate removal and adjustment, such as with a chain-type wrench or a box-end wrench if suitable flats 56 are machined into the outer nose surface 54, as shown in FIGS. 6 and 7.

Bearing adjustment is accomplished by putting a dial indicator on the exposed end of the drive shaft 8 and seating the drive shaft 8 and bearing assembly 6 to the opposite side of the housing 2. The indicator is zeroed and the drive shaft 8 pulled to obtain the initial setting. The adjustment ring 18 is then rotated until the dial indicator reads the correct bearing setting. If a preload condition is required, an additional dial indicator is placed on the adjustment ring 18. After the bearing assembly 8 is set to zero float condition, the indicator on the adjustment ring 18 is read while the adjustment ring 18 is turned in to the final preload value.

To seal oil from leaking through the threaded section of the nut, a chemical sealant, mechanical sealant such as deformed or tapered threads, Teflon tape, nylon ring, or a combination of chemical and mechanical means can be used. Commercially available chemical compounds or mechanical means can be used to keep the adjustment ring 18 from rotating once the bearing assembly 8 is adjusted. Chemical compounds can be, but are not limited to, thread sealants, gasket eliminators or thread-locking compounds. Mechanical methods to lock the adjustment ring 18 can be, but are not limited to, staking the threads, a nylon locking element, a locking tab or doweling between the adjustment ring 18 and the housing 2.

Thus there has been described herein a gear drive that has a continuously variable float and preload bearing adjustment system with an integral seal carrier for the bearings on drive shafts that have a fixed axial alignment within the gear drive, the adjustment system comprising a housing bore in a housing for the gear drive with threads that mate with threads in a combination bearing adjustment and drive shaft seal carrier to provide continuous adjustment of drive shaft bearings without disassembly. It should be understood that the embodiment described above is only one illustrative implementation of the invention, that the various parts and arrangement thereof may be changed or substituted, and that the invention is only limited by the scope of the attached claims.

What is claimed is:

1. A gear drive having at least one continuously variable drive shaft bearing float and preload adjustment system with an integral seal carrier for a bearing assembly on a drive shaft that protrudes from the gear drive that comprises:
a threaded housing bore in a housing for the gear drive;
a threaded adjustment ring with ring threads that mate the threads in the housing bore and a thrust surface that constrains a bearing assembly for a drive shaft that protrudes from the housing in fixed axial alignment through the adjustment ring to provide adjustable float and preload of the bearing assembly; and
at least one shaft seal mating with the drive shaft mounted within the adjustment ring.

2. The gear drive of claim 1 wherein the threaded adjustment ring is loosened within the housing bore to increase float of the drive shaft bearing.

3. The gear drive of claim 1 wherein the threaded adjustment ring is tightened within the housing bore to increase preload of the drive shaft bearing.

4. A bearing assembly float and preload adjustment system with an integral seal carrier for a drive shaft that protrudes from a gear drive housing in fixed axial alignment with the housing, comprising:
a threaded housing bore in the housing for the gear drive;
a threaded adjustment ring with ring threads that mate the threads in the housing bore and a thrust surface that constrains a bearing assembly for the drive shaft to provide a continuously variable float and preload for the drive shaft bearing assembly; and
at least one shaft seal mating with the drive shaft mounted within the adjustment ring.

5. The bearing assembly of claim 4 wherein the threaded adjustment ring is loosened within the housing bore to increase float of the drive shaft bearing.

6. The bearing assembly of claim 4 wherein the threaded adjustment ring is tightened within the housing bore to increase preload of the drive shaft bearing.
